(19) United States
(12) Patent Application Publication
(10) Pub. No.: US 2006/0097693 A1
(43) Pub. Date: May 11, 2006

(54) Battery pack having short circuit prevention function

(76) Inventors: Yong Shik Kim, Youngin-si (KR); Jin Sung Kim, Youngin-si (KR); Jin Hee Kim, Youngin-si (KR)

Correspondence Address: H.C. PARK & ASSOCIATES, PLC, 8500 LEESBURG PIKE, SUITE 7500, VIENNA, VA, 22182, US

(21) Appl. No.: 11/250,570

(22) Filed: Oct. 17, 2005

(30) Foreign Application Priority Data
Oct. 18, 2004 (KR) 10-2004-0083274

(51) Int. Cl. H02J 7/00

(52) U.S. Cl. 320/107

(57) ABSTRACT

Conventional rechargeable battery packs for portable electronic products possess charging terminals for connecting the battery packs to charging devices. When a portable electronic product is in use, there is a potential for short circuiting the battery pack by connecting one or more objects to the exposed charging terminals. This invention provides a battery pack for a portable electronic product with a short circuit prevention function where the charging terminal is exposed only when plugged into a charging device. By protecting the charging terminals, the invention prevents a short circuit from occurring during normal operation of the portable electronic product. The battery pack with a short circuit prevention function comprises a spring-loaded cover that is adapted to travel over the main body of the battery pack to alternately cover and expose the charging terminal.

### CROSS REFERENCE TO RELATED APPLICATION

This application claims priority to and the benefit of Korean Patent Application No. 2004-0083274, filed on Oct. 18, 2004, which is hereby incorporated by reference for all purposes as if fully set forth herein.

### BACKGROUND OF THE INVENTION

1. Field of the Invention

The present invention relates to a battery pack having a short circuit prevention function wherein the charging terminal is covered during normal use to prevent a short circuit between charging terminals.

2. Discussion of the Background

Recent portable electronic products, including household wireless telephones, cellular phones, personal communication systems, and personal digital assistants use a battery pack for an operating power source, which is charged by a charging device. The battery pack has charging terminals with positive (+) and negative (−) polarities for connecting the battery pack to the charging device.

These portable electronic products can be very small size and can be carried in the hand or in a pocket. The charging terminals may be short-circuited to each other by sweat on the hand, when the product is carried by hand, or by various metallic items including a necklace, a coin, a key, or a wristwatch, which may be placed in the pocket together.

Battery packs may include protective circuits to avoid overcharging, overdischarging, and a short circuit. However, a battery pack may abnormally generate heat, catch fire, and explode before the protective circuit is actuated or where the protective circuit malfunctions.

### SUMMARY OF THE INVENTION

This invention provides a battery pack with a short circuit prevention function wherein the charging terminal is exposed only when plugged into a charging device to prevent a short circuit from occurring to the charging terminal during normal use.

Additional features of the invention will be set forth in the description which follows, and in part will be apparent from the description, or may be learned by practice of the invention.

The present invention discloses a battery pack comprising a main body, a chargeable/dischargeable electrode assembly contained in the interior of the main body, one charging terminal exposed to the exterior of the main body and coupled to the electrode assembly, and a cover coupled to the main body and adapted to cover and expose the charging terminal.

The present invention also discloses a battery pack comprising a main body with a first surface that is approximately planar and a second surface that is approximately planar, guide members disposed on opposing sides of said main body, a cover with a first surface that is approximately planar and a second surface that is approximately planar and with edges formed to slide inside said guide members, at least two charging terminals mounted on the exterior of the main body, an electrode assembly housed inside the interior of the main body and coupled to at least one of the charging terminals, and a spring coupled to the cover and main body. The cover is adapted to expose the charging terminals when the cover is open, and adapted to cover the charging terminals when the cover is closed.

The present invention also discloses a method for charging a battery pack, where the battery pack comprises a main body, guide members on the main body, a cover that slides along the guide members with a recess in the cover, a charging terminal mounted on the exterior of said main body, an electrode assembly housed inside the interior of the main body and coupled to the charging terminal, and a spring coupled between the cover and main body. The method for charging the battery pack comprises aligning the recess in the cover with a protrusion on a charging device, sliding the main body onto the charging device a predetermined distance, sliding the cover along the guide members to expose the charging terminal, coupling the charging terminal to the charging device, and removing the battery from the charging device. When the battery is removed from the charging device, the spring automatically closes the cover and covers the charging terminals.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1A shows a front view of a battery pack with a short circuit prevention function according to the present invention with its cover closed.

FIG. 1B shows a front view of a battery pack with a short circuit prevention function according to the present invention with its cover open for charging.

FIG. 1C shows a section view of the battery pack, taken along line 1-1 of FIG. 1A.

FIG. 1D shows a partial section view of the battery pack cover, taken along line 2-2 of FIG. 1A.

FIG. 1E shows a section view of the battery pack and a range of operation of the battery pack cover, taken along line 3-3 of FIG. 1A.

FIG. 2A shows a section view of a battery pack with a short circuit prevention function according to the present invention right before being coupled to a charging device.

FIG. 2B shows a section view of a battery pack with a short circuit prevention function according to the present invention after being coupled to a charging device.

FIG. 3A shows a battery pack with a short circuit prevention function according to the present invention, coupled to a portable electronic product.

FIG. 3B shows a portable electronic product, during charging, coupled to a battery pack with a short circuit prevention function according to the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

In the following description and drawings, the same reference numerals are used to designate the same or similar components, and so repetition of the description on the same or similar components will be omitted.

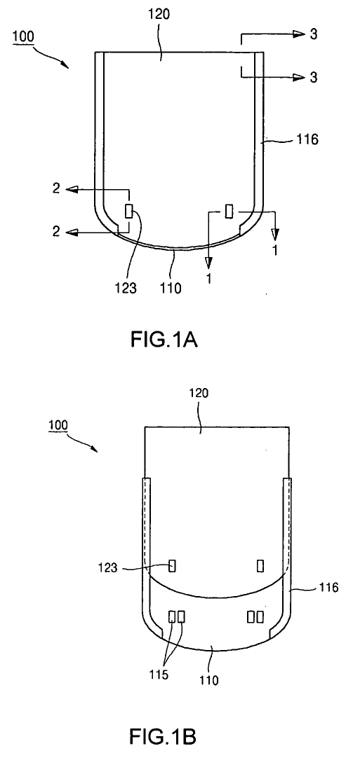

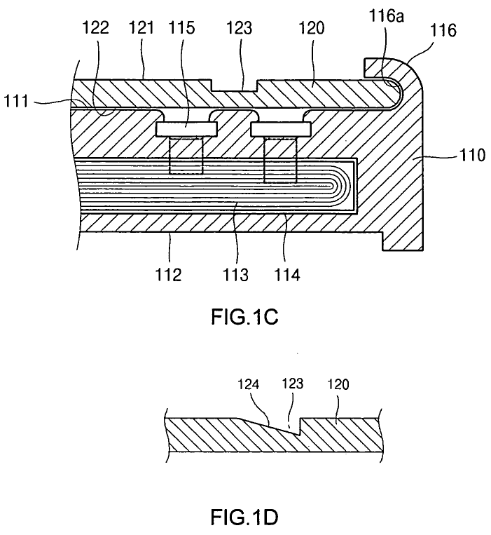

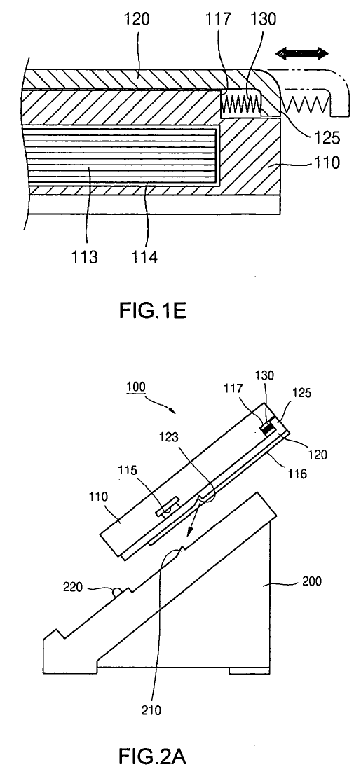

As shown in FIGS. 1A through 1E, a battery pack 100 with a short circuit prevention function according to the present invention includes a main body 110 having an electrode assembly 113 contained therein and at least one charging terminal 115 exposed to the surface thereof and a cover 120 coupled to the main body 110 in such a manner that it can slide or travel to cover or expose the charging terminal 115.

The main body 110 has an approximately or completely planar first surface 111 and an approximately or completely planar second surface 112 opposing the first surface 111. An electrode assembly 113 having positive and negative electrode plates laminated or wound a number of times with a separator interposed between them, as well as an electrolyte injected therein, is positioned between the first and second surfaces 111 and 112. The electrode assembly 113 is sealed by a can or pouch 114. At least one charging terminal 115 is exposed to the first surface 111 while being connected to the electrode assembly 113. As will be illustrated later, the charging terminal 115 is connected to a terminal of a charging device to charge the battery pack 100.

The main body 110 has guide members 116 formed on two edges of the first surface 111 with a predetermined length while extending along the longitudinal direction thereof. The edges of the cover 120 are formed to slide inside the guide members 116, which extend out from the main body 110 by a predetermined depth 116a. Both guide members 116 approach each other along the downward direction of FIGS. 1A and 1B to prevent the cover 120, which is coupled to the guide members 116, from traveling beyond a predetermined distance in the downward direction.

The cover 120 has an approximately or completely planar first surface 121 and an approximately or completely planar second surface 122 opposing the first surface 121. The cover 120 has a recess 123 formed on the first surface 121 with a predetermined depth to be coupled to a protrusion, shown in a later FIG., of a charging device for sliding or traveling. The recess 123 may be provided with a sloped surface 124 having a predetermined angle, as shown in FIG. 1D, for smooth coupling to the protrusion of the charging device. The second surface 122 of the cover 120 contacts the first surface 111 of the main body 110. The both lateral ends of cover 120 are coupled to the guide members 116 to prevent lateral motion of cover 120.

As shown in FIG. 1E, the main body 110 has a step 117 formed to a predetermined depth on the upper side in the drawing, and the cover 120 has a corresponding protrusion 125 formed thereon with a predetermined length. A spring 130 having a predetermined elastic force may be coupled between the step 117 and the protrusion 125. The spring 130 causes the cover 120 to remain closed, thus covering the charging terminal 115 of the main body 110 during normal operation such as when coupled to a portable electronic product.

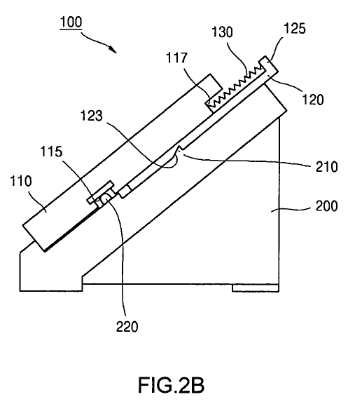

As shown in FIG. 2A, when the battery pack 100 is uncoupled to a charging device 200, the cover 120 is closed due to the elastic force from the spring 130. The charging terminal 115 formed on the main body 110 is not exposed to the exterior in this state and a short circuit is prevented from occurring to the charging terminal 115 due to external liquid or metallic items.

As shown in FIG. 2B, when the battery pack 100 is coupled to the charging device 200, main body 110 slides downward on the charging device 200 while the protrusion 210 of the charging device 200 is coupled to the recess 123 formed on the cover 120. Protrusion 210 coupled to recess 123 prevents the cover 120 from sliding downward with main body 110, spring 130 lengthens, and cover 120 extends a predetermined distance into the open position. As the cover 120 opens, the charging terminal 115 formed on the main body 110 is exposed to the exterior and connects to the terminal 220 protruding from the charging device 200. When the charging terminal 115 is electrically connected to the terminal 220 formed on the charging device 200, the charging process begins.

When the battery pack 100 is released from the charging device 200, which may be upon completion of the charging process, the elastic force from the spring 130 causes the cover 120 to return to the original position along the guide members 116. The charging terminal 115 formed on the main body 110 is again covered by the cover 120 and protected from the external environment.

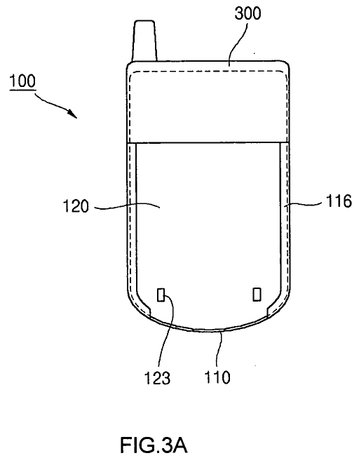

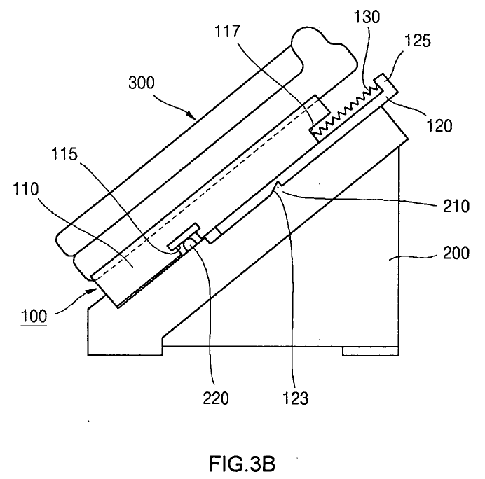

As shown in FIG. 3A, the battery pack 100 according to the present invention can be coupled to a portable electronic product 300 and used as a power source. Although a cellular phone has been illustrated as the portable electronic product 300, the present invention is not limited thereby. In addition to a cellular phone, for example, the portable electronic product 300 may be a household wireless telephone, a PCS, or a PDA.

As shown in FIG. 3B, the battery pack 100 according to the present invention can be coupled to the charging device 200 and charged, while simultaneously coupled to a portable electronic product 300. The cover 120 coupled to the battery pack 100 can slide a predetermined distance in a predetermined direction without any interference from the charging device 200 or the portable electronic product 300, so that the charging terminal 115 can contact the terminal 220 on the charging device 200. When the portable electronic product 300 is separated from the charging device 200, the cover 120 slide and returns to the original position by means of the restoration force from the spring 130. The charging terminal 115 is then again protected from the external environment.

As mentioned above, the inventive battery pack having a short circuit prevention function is advantageous by covering the charging terminal during normal operation and a short circuit is prevented from occurring to the charging terminal due to external liquid or metallic items. Additionally, the charging terminal is prevented from being corroded by various contamination sources while the cover is closed and the aesthetic appearance of the battery pack improves.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A battery pack, comprising:
a main body;
a charging terminal; and
a cover coupled to the main body and covering the charging terminal.

2. The battery pack of claim 1, wherein said cover opens to expose said charging terminal for recharging the battery pack.

3. The battery pack of claim 1, further comprising:
guide members formed along two sides of the first surface of the main body;
wherein the edges of the said cover are formed to slide inside the guide members.

4. The battery pack of claim 3, wherein said guide members extend a predetermined distance from the main body.

5. The battery pack of claim 4, wherein the guide members are disposed on opposing sides of the main body, and are arranged closer together on one edge of the main body than the other edge to inhibit sliding of the cover in a predetermined direction.

6. The battery pack of claim 1, wherein said main body has an approximately planar first surface, and an approximately planar second surface opposing the first surface.

7. The battery pack of claim 6, wherein said cover has an approximately planar first surface and an approximately planar second surface opposing the first surface.

8. The battery pack of claim 7, further comprising:
a recess formed on the first surface of the cover wherein a protrusion on a charging device will engage the recess and slide the cover in a lateral motion to an open position.

9. The battery pack of claim 8, wherein said recess has a sloped surface formed thereon so that its depth gradually increases.

10. The battery pack of claim 1, further comprising:
a protrusion formed on an end of the cover;
a step formed on the main body that corresponds to the protrusion of the cover; and
a spring coupled between the protrusion and the step to return an opened cover to the closed position.

11. The battery pack of claim 1, wherein said main body is coupled to a portable electronic product.

12. The battery pack of claim 11, wherein said portable electronic product is a household wireless telephone, a cellular phone, a personal communication system, or a persal digital assistant.

13. The battery pack of claim 12, wherein the battery pack is concurrently coupled to a portable electronic product and a charging device for recharging the battery pack.

14. A battery pack, comprising:
a main body with a first surface that is approximately planar and a second surface that is approximately planar;
guide members disposed on opposing sides of said main body;
a cover with a first surface that is approximately planar and a second surface that is approximately planar, and with edges formed to slide inside said guide members;
at least two charging terminals mounted on the exterior of said main body;
electrode assembly housed inside the interior of said main body and coupled to at least one of said charging terminals; and
a spring coupled to said cover and said main body;
wherein said cover is adapted to expose said charging terminals when the cover is open, and adapted to cover said charging terminals when the cover is closed.

15. The battery pack of claim 14, wherein the spring is at a minimum length when the cover is closed and stretches when the cover is opened.

16. The battery pack of claim 15, wherein the battery pack is concurrently coupled to a portable electronic product and a charging device for recharging the battery pack.

17. The battery pack of claim 16, further comprising:
a sloped recess in said cover for holding said cover open while the battery pack is coupled to a charging device.

18. A method for charging a battery pack with a cover over a charging terminal, comprising:
opening the cover to expose the charging terminal;
coupling said charging terminal to said charging device.

19. The method of claim 18, wherein said battery pack is coupled to a portable electronic product throughout the duration of said method.

20. The method of claim 18, further comprising:
uncoupling said battery pack from a portable electronic device; and
coupling said battery pack to a portable electronic device.
